(19) United States
(12) Patent Application Publication
(10) Pub. No.: US 2009/0265245 A1
(43) Pub. Date: Oct. 22, 2009

(54) COMMUNICATIONS PLATFORM FOR ENABLING BI-DIRECTIONAL COMMUNICATION BETWEEN PROVIDERS CONSUMERS AND ADVERTISERS USING A COMPUTER NETWORK AND/OR MOBILE DEVICES USING DESKTOP AND OR MOBILETOP INTERACTIVE WINDOWLESS VIDEO

(76) Inventor: Rocky J. Wright, Corona, CA (US)

Correspondence Address: BUHLER ASSOCIATES;BUHLER, KIRK A., 1101 CALIFORNIA AVE., SUITE 208, CORONA, CA, 92881, US

(21) Appl. No.: 12/419,938

(22) Filed: Apr. 7, 2009

Related U.S. Application Data
(63) Continuation of application No. 11/426,920, filed on Jun. 27, 2006.
(60) Provisional application No. 60/694,126, filed on Jun. 27, 2005.

(51) Int. Cl. G06Q 30/00; G06F 15/16

(52) U.S. Cl. 705/14.66; 705/14.73; 705/27; 709/206; 725/34

(57) ABSTRACT

A system and method for enabling continuous, interactive, bi-directional communication between providers and consumers/recipients of information and advertisement in a Browser Free environment displayed on a computer desktop and mobile device utilizing traditional media, but with transparent borders with no visible video or media player. The platform provides entertainment, exchange of products, services and preference information with just people, cars, animals, etc. walking around and interacting with each other and the consumer/recipient, on the desktop but without the use of the Browser. The access point is a single dynamic icon that changes in look, shape, and media properties etc. when information is provided to consumers/recipients. The icon consolidates an unlimited number of provider accesses through the single icon, enabling the consumers/recipients to receive an unlimited number of provider access points consolidated into one icon. A commission accounting module calculates commissions where applicable.

### CROSS REFERENCE TO RELATED APPLICATION

This application is a continuation-in-part of applicant's co-pending application Ser. No. 11/426,920 filed Jun. 27, 2006 which claims priority to the applicants provisional 60/694,126 filed Jun. 27, 2005 the entire contents of which is hereby expressly incorporated by reference herein.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC

Not Applicable

### BACKGROUND OF THE INVENTION

1. Field of the Invention

This invention relates to conventional communications for business and advertising as well as electronic advertising and e-commerce. The system allows providers of content, products, services, and/or information to target willing consumers and willing consumers to select preferred providers while enabling communications between the two groups. Specifically, this invention relates to intelligent information processing methods for creating content and sending to targeted groups and individuals, while providing relationship building tools for the providers and users, all through a bi-directional communications platform including but not limited to PC's, Mac's PDA's and cellular devices.

2. Description of Related Art Including Information Disclosed Under 37 CFR 1.97 and 1.98

A communications platform and method for enabling continuous bi-directional communication between providers and consumers of products and services through a computer, mobile, television and telephone network. This invention facilitates the exchange of products, services, preferences, and information. The system and method of the invention provides a database having accounts for providers and consumers. Each account has an ever-intelligent, on-going information gathering, storing, and redistribution capability. Account information without limit to the amount of data being collected that includes contact, warranty, product, and billing information for providers; and contact, demographic, product preference, contact permissions, and usage history information for consumers. The invention provides an area or icon/agent for consolidation, of all provider access points in a single icon in the system tray and/or desktop agent interface on the user's computer, mobile or communication device. The invention creates a communications and ad reviewing cart that allows users to select providers and content to be received. Content is received and sent through a portal that is created and that can be accessed via a single icon in the system tray that houses any number of providers to active, bi-directional agents, advertisers, consumers, providers, and a host company. An information warehouse manager is employed to receive data from providers and users. A commission accounting module calculates commissions.

The communications between advertisers and providers and users and consumers leverages the consumer and provider databases. By providing advertisers with a communications platform to reach a targeted group of willing consumers and thereby enabling them to customizing their messages, while at the same time allowing consumers to detail the type, content, and frequency of the messages and information that they receive, both sides benefit. The platform allows the monetization of advertising communications, e.g. by charging advertisers to access the consumer databases and customize their advertisements. The platform provides users with a flexible, dynamic, expandable ITT Icon/Agent, that appears on his or her system tray, television or mobile device, through which the user controls communications with the providers.

An important advance within the communications platform is the use of Desktop interactive windowless video DIWV™. DIWV™ gives the user live images without the overhang of visible background media players or browsers. Due to the new technology for presenting images, new types of content or advertising become reality. Once an alert shows up through the user's ITT Icon/Agent, a multitude of new forms of entertainment, advertising, and mobile top or television top desktop interactions become possible. Once the user opts-in, responds to an alert, and becomes actively involved with the communications platform, the necessary data for tailoring advertising messages starts to be collected. And then the invention allows for charging for access to the databases and incorporating the money-making business model as described below. In essence, the invention creates new advertising real estate on the computers desktop, television top, mobile or handheld device, without actually requiring the World Wide Web/browser, and provides a new business model for monetizing communications through the ITT Icon/Agent on the desktop, television top without the need for a broadcasting network and on the mobile devices.

Brand managers and advertisers are able to monitor their campaigns through user-friendly, creative, and detailed reporting systems. The types of information tracked include any collected data such as but not limited to gender, geographic location, age, interests and income. These reporting systems provide specific information about the target users and consumers. The database is always growing dynamically by user interaction in the system and therefore increases the targetability of users from advertisers. Monetization is also through a subscription base.

ITT technologies bridge the gaps among and between on-line marketing, traditional communications, and the mobile environment. An on-line agent provide a messaging and alerting system that allows advertisers and consumers to exchange information while enabling providers to send alerts dynamic information to and consumers to users. This agent is stored on the system tray of the computer and or users' mobile or desktop or television top devices as a single icon. The icon stores all of the information and links necessary for users to access any number of providers and advertisers and providers and advertisers to access users, in compressed mode, the agent/icon appears as a single icon; in expanded mode, the agent/icon expands to a list of many providers and their access points or links.

Prior Art

| | | |
|---|---|---|
| 5,347,632 | Sep. 13, 1994 | Prodigy |
| 5,761,648 | Jan. 02, 1998 | interactive Coupon 'Network |
| 5,948,061 | Sep. 07, 1999 | Double Click, Inc. |
| 6,009,413 | Dec. 28, 1999 | America Online, Inc. |
| 6,026,368 | Feb. 15, 2000 | 24/7 Media, Inc. |
| 6,029,141 | Feb. 22, 2000 | Amazon.com |
| 6.269,361 B1 | Jul. 31, 2001 | Goto.eom |
| 6,332,129 B1 | Dec. 18, 2001 | pneeline.com |
| 6,381,594 B1 | Apr. 30, 2002 | Yahoo! Inc. |
| 6,525,747 B1 | Feb. 25, 2003 | Amazon. Com |
| 0078928 A1 | Apr. 24, 2003 | Dorosario et al |
| 0216335 A1 | Sep. 29, 2005 | Fikes et al |
| 222901 A1 | Oct. 06, 2005 | Agarwal et al |
| 0222989 A1 | Oct. 06, 2005 | Haveliwala et al |
| 0004627 A1 | Jan. 06, 2006 | Bakijaeta |

Many examples of two-sided markets exist: Videogame platforms, such as Atari, Nintendo, Sega, Sony Play Station, and Microsoft X-Box need to attract gamers or users in order to recruit game developers to design, port or produce games for their platform while also needing games in order to induce gamers to buy and use their product. Similarly, software producers need both users and application developers. Portals, web-sites, T. V. and radio networks, newspapers and other print media compete for advertisers as well as “eyeballs”.

Advertiser-consumer markets are another example of two-sided markets because both sides have information, products, services, content or data that are valuable to the other side. However, the expense and difficulty of communications between providers and users prevents establishing a fully functional direct market, between the two.

In the advertising-consumer markets, problems persist in enabling communications between the advertiser and the consumer. The costs in terms of time and labor to collect data on individual consumers are high. Typically there is no reward for collecting or making the information available because no-one is willing to pay for it or once it becomes available the provider loses any competitive advantage they had in collecting the information. On the other hand, consumers continue to face a daunting array of Web sites, unsolicited e-mails, spam, and other information. Finally, consumers and to some extent businesses are concerned about privacy and overload since junk e-mail and identity theft are major threats. Once the database is collated there is no effective way to continue communications unilaterally.

Ultimately, however, there remain substantial benefits for both advertisers and consumers to participate in building long-term relationships by exchanging information through a platform that they both control. The goal of advertisers is to target marketing communications to individual consumers based on demographic and behavior data while the goal of consumers is to receive as much information as they want to make informed choices without being inundated or losing their privacy. The goal of both parties is to avoid high costs and minimize time and expense of participating and to not be contacted by unwanted or uneconomical solicitations.

Within the advertising industry a long-standing goal is to provide individualized ads that are targeted to selected consumers in a non-offensive manner. Traditional radio, T.V., newspaper, and other print media advertising reach a large audience. While the target is large, the efficiency of these mass media is low. Moreover, there is no way for the provider to pick out of the mass audience from those individual consumers that are most likely to respond to the message.

In the mass media advertising campaigns, the individual consumer has little or no influence on the content or targets of the advertising campaigns. Even if consumer data is collected at the point of sale or the consumer fills out a questionnaire, there is little opportunity for the advertiser or provider to modify their campaign in time to respond effectively to input or feedback from the user. Thus, significant opportunities for interaction between advertisers and consumers never materialize, 'thus, there is a need in the industry for a bi-directional communications medium for advertisers to send content to users, for users to consume the message and respond to the providers, and then for providers to send further targeted marketing communications, especially outside the world of emails.

The traditional advertising models have been grafted onto the on-line world. However, mass e-communications of e-mail and indiscriminate use of pop-up ads turn off consumers just as effectively as traditional mass mailings. Nonetheless, the Internet still presents great opportunities for matching buyers with sellers and providers of information with consumers.

From the very beginnings of the internet, using dial-up access has made the lives of consumers better by creating an online experiences that informs and delights. With the increasing popularity of the Internet and the World Wide Web, it has become common to buy, sell, and advertise on the Internet. To-date, the conventional advertising and retailing models have been adapted to the Internet with some success in terms of ease of use and sales. However, one remaining problem for providers is that there is no easy means for sellers and buyers to establish a relationship before and no mechanism for building the relationship post-sale based on the individual preferences of the consumer.

AOL created unique channel navigation and improved Internet search features, including audio/video and local search while providing original content. AOL bridged the gap between the providers and consumers by creating on-line communities. Although a pioneer in making online communications easy and fun, including on-line advertising, the AOL model of using banner ads and click-ons ads is limited. A significant problem remained that there was no way to establish continuous relationships between the advertisers and consumers because once the consumer clicked-on a banner advertisement, there was little to hold him to the site of the advertiser.

Even as e-commerce grew tremendously, buyers and sellers were still separated, until eBay developed an online person-to-person trading community. Buyers and sellers are brought together through online auctions in which sellers list items for sale and buyers bid. EBay users browse through listed items and the items are arranged by topics, where each type of auction has its own category. EBay's online format provides continuous dialogue between buyers and sellers and facilitates easy offering and bidding, both globally and locally. Still, there is little reason or capacity for either party to establish a long-term relationship beyond that of buyer and seller or extending beyond the trading arena.

In an attempt to allow relationship building, eBay and other companies now provide entire platforms for operating businesses with feedback forums. However, eBay's method for obtaining information from consumers is limited to registered sellers and buyers. The focus remains with on-line trading and the exchange of goods and services, with no mechanism to facilitate the exchange of information from sellers and preferences of buyers that would lead to longer-term relationships. Thus, there remains a need in the industry for a means for exchanging information between providers and users well before a transaction takes place, and even between parties which may never transact business in the traditional sense.

As the number and type of e-commerce transactions continued to grow, there were only limited means for using the information from one transaction to generate another, until Amazon started tracking user buying patterns in order to cross-sell users a wide range of items suited to their personal tastes. Amazon's method for obtaining information from consumers is limited to cross-selling where sales and purchases have already taken place. The merchant's ability to glean information about a potential customer is limited still to the data collected by the website. Thus, there is a need in the industry for enabling communication between sellers and buyers along the entire continuum of interactions, from actual sales and purchase transactions to expressions of interest in products and brands by consumers to focus group marketing by sellers.

Finding information and websites on the internet has always been easy, but presenting the results in a useful format has always been difficult. In the absence of the bid-for-placement mechanism, ad pricing is inefficient. Hence, on-line advertising had limited potential, until Overture pioneered the bid-for-placement mechanism that allowed advertisers to change the rank of their ads. However, the bid-for-placement mechanism was limited to subscribers, and there was no means for storing information pertaining to the bid and the targeted consumer over a long period of time. The bid-for-placement was an innovation because it enabled the pricing of ads based on perceived value, but its scope is limited to on-line advertisers and buyers who participated in Internet search. Thus, there remains a need in the industry for a means for providers to place information where those who want to receive it, while allowing either side to bears the costs through making payments or participating in the program.

Google pioneered indexed-based searches and subsequently linking search results to ads. Google's profitability comes from its search technology combined with text ads and an ad placement mechanism. Advertisers bid for placement of their ads (bid-for-placement mechanism). Goto.com created a system for influencing a position of a search in a result list. Bid-for-placement frees up extensive resources that would otherwise be required to set ad prices, and it allows advertisers to charge ad sponsors in proportion to the value added by the advertiser. However, the full value added of advertising that reflects the input of both advertisers and users remains to be realized because the consumer plays no part directly. In its various forms, bid-for-placement still does not enable continuous communication between the provider and user, or the advertiser and consumer or maximizing of value added in the advertiser-consumer market.

Google pioneered the link between index-based searches and advertising. Google focuses on delivering contextual based advertising through the AdWords program. Google reaches people when they are actively looking for information about products and services online by offering a link to or sending users to targeted web sites and pages. AdWords enable providers to control costs by charging only when people click on their ads. Google AdSense™ automatically delivers text and image ads that are precisely targeted to an advertiser's site and content. However, this technology does not allow users to establish a relationship with the provider that is independent of the internet.

Amazon pioneered an internet-based customer referral system. Individuals and businesses (“associates”) market and sell products in return for a commission.

In today's environment, with searches and ads integrated with user preferences and past behavior and with so many options open to the consumer and so many on-line transactions, it has become difficult for consumers to keep track of all their past transactions and current points of interest in products and providers. Thus there is a need in the industry for a consolidated single point of access to all providers as well as a common communication platform between providers and users.

With so many providers making so many types of information available, making all content available through a single platform has become impossible. Thus there is a need in the industry for a single platform and format for creating content, soliciting and storing data from users and consumers, and enabling users to access providers through a single access point.

Although information on consumers from prior searches and sales are now routinely gleaned and amalgamated, there remains a need in the industry to extend the scope of such data mining beyond sales data to all aspects of pre- and post-sales, including exchanging information about brands and products along with consumer data and preferences. There is also a need in the industry for providers and consumers to exchange information, and for each party to analyze and respond accordingly.

Push. The transfer of information between providers and consumers has become both widespread and pervasive. Today advertisers and brand managers have a plethora of content distribution channels, but also rising costs and inefficiencies. Consumers increasingly are able to dynamically communicate with brand managers through games and promotions, but have little influence on the information they receive.

Transferring information over computer networks is an increasingly important means for institutions and individuals to do business and become informed. Such information transfers occur both publicly on the Internet, which is a worldwide interconnection of computer and computer networks using a common protocol, and privately through virtual private networks (VPNs), which are smaller, propriety internets. Taken together, the Internet and VPNs are evolving into a global electronic market place of goods and services and ideas and information.

Providers and advertisers of products, information, and services find the Internet to be an attractive new communication medium. Consumers and users are also increasing their use of the Internet. Mechanisms such as directories and search engines index and organize the information on the web. The search engines then allow users to search the Internet for a listing of web sites and pages based on a specified topic, product, service or word or group of words.

Search services offer advertisers extensive reach into the Internet audience and provide opportunities to target consumers based on their use of keywords and search topics. The search engines and web site directories of the prior art, although now used extensively with by advertisers, still provide no means for the brand managers and providers to stay in touch with the users and consumers.

Pull. Today's consumers obtain information on products and services through a variety of media. Traditional means include newspaper advertising, magazine ads, and other print media. Free product samples entice the user to try and later buy. CDs are used to describe a product using visual and audio.

Despite the multitude of entertaining and informative advertising methods targeted to and used by today's consumers, there is still no easy way for a consumer to communicate or stay in touch with the provider or brand manager.

The usefulness of the present invention is to provide bi-directional communication between the providers and users. The invention can be used in a variety of contexts, from advertiser-consumer, information provider-reader, musician-fan, and manufacturer-buyer.

When a computer device is mentioned with this invention, a device with both computing and communications capabilities are intended.

Background of the Invention and Advertising Models on the Internet.

Search services are the most frequently used tool 011 the internet after e-mail. Search services have offered advertisers significant penetration into the internet audience while providing targeting opportunities through keyword and topical search requests. However, the information derived from search requests and any subsequent purchases fail to establish a full and equal relationship between the provider and the consumer. Thus, there is a need in the industry to extend the relationship beyond the initial search and subsequent purchase so that the user may tailor the content and choose the permitted senders.

One problem with existing advertising model is their indiscriminant broadcasts of unsolicited communications. Once a user buys on-line, they are then potentially subjected to dozens or hundreds of following ads. A related problem is that there is no easy way for the user to signal their willingness to receive such communications within their own specified limits or to influence their content. Hence, there is a need in the industry for a means for communicating in both directions between providers and users the preferences and information that each has.

The web advertising model extends traditional media broadcast models. The broadcaster, i.e. a web site, provides content—usually for free—and services such as email, chat and blogs—mixed with advertising messages in the form of banner ads. The banner ads may be the major or sole source of revenue for the broadcaster. The broadcaster may be a content creator or a distributor of content created elsewhere. The advertising model works best when the volume of viewer traffic is large or highly specialized. However, current paradigms for internet advertising fail to utilize the unique attributes of the internet or provide a means to sustain the relationship between providers and users off the internet.

Data about consumers and their consumption habits are valuable, especially when that information is carefully analyzed and used to target marketing campaigns. Independently collected data about producers and their products are useful to consumers when considering a purchase. Some firms function as infomediaries (information intermediaries) by assisting buyers and/or sellers understand a given market. However, current technology fails to provide sufficient information in a timely manner such that the provider may tailor content and the target based on results and user response, much less in substantial real-time.

Traditional models of advertising and search engine technology have failed to effectively deliver relevant information to interested users. Ideally, providers should be able to control their placements so as to maximize effectiveness while minimizing annoyance. Similarly, consumers should be able to control the flow of content and advertisements sent to them. Thus, there is a need in the industry for a bi-directional communications platform between providers, mainly advertisers, and users, mainly consumers.

With proper tools; advertisers should be able to customize their content for a select group of consumers and then communicate their targeted advertisements solely to those users who are most interested in receiving them. Ideally, the provider should be able to adjust the content of their campaigns based on results and user input, while consumers should be able to adjust the amount and type of communications targeted and sent to them. There is a need in the industry for a systems and means for enabling interactive or intelligent communications between providers and consumers.

### BRIEF SUMMARY OF THE INVENTION

The present invention seeks to solve the aforementioned problems by providing a system and method for enabling communication between providers and users so that the user may opt-in and specify the provider, type, number, content, and sources of communications while the providers may tailor their content in substantially real-time by analyzing the user input and data. In addition, the present invention allows users to influence the provider, number, content, and type of communications received.

In a preferred embodiment of the present invention, an advertiser selects the targeted consumers based on both the static user information and the dynamic user information in the database and then tailors the advertisement to maximize the likelihood of success, and in turn, the results of the campaign and further responses from users are fed back into the process thereby adding to the database to produce iteratively highly tuned ad campaigns.

To participate in this process, a provider initially creates content tied to a product or service. The provider supplies some means of communication for the end user. E.g. a CD or click-on area on a web page. The provider enables the user to join or opt-out or do something in between, so that the users receive all of the provider content, some of the content or none at all. However, the user always has the ability to change their receiving preferences.

As part of the invention, users must register before receiving any targeted communications from providers. Once the user opts-in, the system retrieves and stores user data, such as age, date of birth, past consumer activity, preferences or anything else that will uniquely identify the user and provide information that can be used to customize targeted communications. The basic user data that is input during the opt-in process is stored in a static user database, while information on purchases and system usage is stored in a dynamic user database tied to the specific user.

The invention allows providers to collect user data from multiple user sessions and opt-ins for further analysis and then intelligently analyze. The user and provider benefit from the amalgamating ability of the system to use user input and data from one provider or input session with one or more subsequent opt-ins. Thus the system creates mutual benefits from returns to scale for both providers and. users.

An important benefit from the amalgamation is that the provider can use data from one session with data from another session of the same user. For example, during an initial opt-in, the user may provide name, address, and age. During a second user session, the same user may provide weight, favorite sports team, and information, on hobbies. The invention provides a means to connect the two sessions with the permission of the user. The user benefits because he does not have to fill out the same basic data each time he want to participate in a current or future provider promotion, while the providers benefit by having access to much more data or television top.

The platform provides for real-time communications and immediate analysis software. Both the provider and the user can react substantially in real-time to the results of advertising campaigns or the information, products, and/or services provided. The invention makes communications easy for the user by consolidating all access methods into a single icon/agent on the taskbar or system tray on the user's communication, computing or mobile device.

According to a first embodiment, the invention provides a system and method for enabling advertisers to establish communications with users through a promotional item. The user follows directions in the promotional item to log in to the advertisers web site and provide static user data such as age, income level, living location, and product preferences. At this time the user also specifies whether to receive additional, communications from the current or other providers. Subsequently, the user may provide dynamic user data by participating in another session to provide feedback to a provider campaign, which information the provider uses to tailor its content and target audience. The web information can dynamically create and agent based on information collected.

As the user opts-in to more providers, all of the access-points to various providers are consolidated into a single, expandable icon/agent on the system tray of the desktop, communication or mobile device, thus causing communications for the user. After the user opts-in to one or more providers, the static and dynamic user data may be amalgamated by one or more providers. The privacy of the user is guaranteed in that information is solicited generally but input is specifically accepted only with the initiative of the individual user. Each user may specify the data that he inputs while also specifying the range of privacy from total anonymity to full disclosure. The invention provides a database system that is separate from any provider or user to store static and dynamic user data, information from the providers, and results of advertising campaigns.

One embodiment of the invention is to provide a system and method for having a database store accounts for providers and individual users. Each account includes contact and billing information for the promoters and usage history and product and provider information for the users. Each provider account includes at least one product or service, while each user account contains static and dynamic user data and usage history. Each account may include payment and detailed usage history, ‘the provider logs into their accounts in order to retrieve information. The users log into their accounts in order to provide static and dynamic user data and usage history or to access content, products, information and/or services.

The present invention addresses the existing problems and bottlenecks in traditional media and Internet advertising and marketing by providing a method and system for bidirectional communication between providers of information and users, and between advertisers and consumers. The invention allows the user to create an information viewing cart and enables the provider to create a user preference-usage cart.

The invention provides added value to any marketing or advertising campaign by allowing the advertiser or brand manager to first gather information on target users, receive responses from them, and then customize and target further advertisements in real-time and automatically and assertively.

The invention provides added-value to the consumer by enabling the consumer to customize the amount, type, and source of advertisements received and read. Instead of relying on a deluge of unsolicited communications, the user instead logs into and chooses those advertisements or targeted marketing communications that he will receive. On the other hand, the user provides any information that could be useful to the advertiser. A method for combining user sessions and data across multiple platforms and advertisements and campaigns is provided, so as to generate increasing returns to scale.

The invention allows several ways of making or generating revenue. The user databases may be licensed entirely or partially, depending on the permission levels granted by the individual users. Pay-for-performance payments may be made by providers based on their use of the invention to increase returns on investments and advertising revenue on pre-determined ad space of information portals and subscription based content delivery.

One embodiment of the invention includes using a bar code and mobile cell phone or other communication device. The basic idea is to have the advertiser or brand manager send a bar code to the cell-phone of the user, so that the bar code may be read by a retailer. Then the retailer may provide the consumer with a promotion based on the bar code. Both the provider and the retailer retrieve and store for later analysis information on each use of the bar codes.

A message created and sent by the provider contains a bar code and accompanying information. The accompanying information includes consumer data that the consumer had put into the system during prior log-in and opt-in sessions. The consumer data also includes prior transaction history as well as preferences specified by the consumer. Analytical software included in the system and method analyzes data available in consumer and provider data warehouses and produces customized bar codes and accompanying information, which are then sent to a group created by the provider based on data in the ware houses as well as data, opt-ins, and preferences specified by the consumer.

The method for using cell-phones and bar-codes with a scanner also includes a confirmation process whereby the retailer may confirm information to and from both the provider and the consumer. The provider may respond in real-time to the scanning activity of the retailers, so that consumers may benefit from any promotional or sales activity associated with created, distributing, and scanning the bar codes.

The provider may modify the bar codes and associated promotional programs as well as prices based on the reaction of the consumer, both collectively and individually. The ability of the retailer to scan bar codes practically immediately after being sent by the provider and received by the consumer has many advantages. For example, fraud is reduced because through security features bogus or counterfeit bar codes are difficult or impossible to produce, since there is an internal and external verification process.

The process and method of the invention follows this general outline:

1. Provider creates product and inputs product data into warehouse.

2. Provider develops advertising or marketing campaign.

3. Consumer develops awareness of product or campaign.

4. Consumer receives a promotional tie-in, such as by buying a coke bottle and reading a promotional code.

5. Consumer may also log-in to the website or programs of the provider.

6. Consumer opts-in to promotional campaigns and/or receiving communications from providers.

7. Consumer specifies preferences.

8. Data from opt-ins and consumer sessions is stored by the provider and system and method for later analysis.

9. Retailer collects data from bar code scanning, and keeps data for local use and to send on back to provider.

One of the advantages of the system is that use of the bar codes can be managed and monitored in real-time.

One component of the system is to create a URL to store information pertaining to the provider, user, and transaction involved in the bar code.

Another component of the system is that the retailer is directed to a web site based on the bar code. Still another component is that the consumer is directed to a website of the provider and/or visa-versa.

It is an object of the present invention to provide a system and method for providers to make content available to users through targeted communications and for users to make their data available through tailored solicitations.

A further object of the invention is to enable the users to solicit targeted communications and to influence the number and type of targeted communications they receive through defining their user preferences while allowing providers to tailor their content based on user input.

It is an object of the invention to provide a search engine based information retrieval system and method for collecting and storing the information, in one mode for providers to create tailored and targeted communications, and in a second mode for users to select, influence, and receive such communications.

it is another object of the invention to provide a cost-effective method of advertising where the provider may tailor and communicate its content to an audience that defines itself in size from mass markets to individually targeted consumers.

A further object of the invention is to provide a system and method for enabling providers to examine the effects of their advertising campaigns and to make substantially real-time changes to their content and targets.

It is another object of the invention to enable users to increase or decrease the number of targeted communications received while also allowing them to influence their content.

It is also an object of the invention to allow a provider and user to establish a relationship beyond a single sale-purchase transaction.

Many advantages can be derived from the above. On-line and off-line advertisements can be targeted based upon provider analysis of the system's databases, user input, preferences, and usage history—as well as user responses.

Another object of the invention is called Camitt that is a Social networking system that provides Global Interactivity. Camitt breaks the trend of closed socialization as is presented by the more traditional social sites such as, MySpace, Facebook, and Beebo, etc. The Global social environment has attributes that allow users from any and all social sites the ability to communicate across social networks while never leaving their own primary site and to do so with a plethora of tools.

Another object is to provide an On Desktop Broadcast Network comprising of a media broadcasting network that provides incredible, fully interactive, rich media content for Entertainment that seamlessly traverses the Web, the Desktop and the Mobile top with creative content. The primary core of the innovation of this Application is our Desktop Interactive Windowless Video (DIwV). The technology allow for Interactive and Responsive rich media content that is presented in a player less environment on the Desktop of a computer. This content can display and be Interactive and Reactionary while the user still has the ability to surf the web, work on excel spreadsheet, or do any of their normal computing activities. The DIwV is made to be non-obtrusive and non-intrusive thus it functions in a Windowless environment. The object is that the system will be providing interactive video for entertainment & communication as well as Desktop Interactive Windowless Video (DIwV) concerts, shows etc.

Another object is to provide Multi-Level Marketing (MLM) that provides interactive communication, with media notifications, personalized direct interaction without individual interaction, downloadable digital content without hard copies or DVD's, application programming interface (API), the ability to send a Friend Viral Component, Social/Lead generation Replicated Site, In Front Videos (IFV) and an advertising Injection Engine using DIwV content.

It is still another object of the invention to create a fair system for creating and sending targeted communications, including advertising, product warranties, and warnings.

It is another object of the invention is to consolidate access to all providers into a single icon/agent located in a desktop, task-bar, and/or system tray.

Various objects, features, aspects, and advantages of the present invention will become more apparent from the following detailed description of preferred embodiments of the invention, along with the accompanying drawings in which like numerals represent like components.

### BRIEF DESCRIPTION OF THE DRAWINGS

FIG. 1 is a high-level illustration of the world of advertising illustrating television, billboards, print media, and an individual target.

FIG. 2A illustrates the ability of itt LiveLoop component to distribute information and services non-obtrusively through the internet while also collecting information from users.

FIG. 2B illustrates how the itt Rom™ an In TouchHotSpot. The In TouchHotSpot presents images without the overhead or appearance of a browser or visible player window. Touch Alerts appear on the user screen.

FIG. 3A illustrates how the itt Rom™ is integrated with marketing and advertising campaigns.

FIG. 3B presents the advantages of itt Rom™ and the invention.

FIG. 4A illustrates the communications features, including chat, video, audio, cell phones, and web casting, to list a few.

FIG. 4B illustrates other features of itt Rom™.

FIG. 4C shows a contemplated screen image showing the integration of the itt Rom™.

FIG. 5A illustrates the benefits to consumers and providers of itt technology.

FIG. 5B illustrates the user initiating use of the In Touch Application.

FIG. 6 compares the advantages of itt Rom™ with the average web site.

FIG. 7 illustrates the benefits of the itt technology across brands of multiple providers.

FIG. 8 illustrates the benefits of itt technology.

FIG. 9 introduces itt Mobile™.

FIG. 10 illustrates the incorporation of itt Mobile™ in various technologies.

FIG. 11 illustrates the Gateway Services™ component.

FIG. 12 further illustrates how a consumer uses a product code.

FIG. 13 provides an overview of itt Com™ and the invention's internet web portal.

FIG. 14 illustrates an overview of itt Com™.

### DETAILED DESCRIPTION

The invention is a platform for enabling an intelligent bi-directional communications between providers of information and users of information. The invention utilizes communications links to enable and enhance communications between the advertisers and providers and the users and consumers; data warehouses to store information on and for advertisers and providers as well as users and consumers. Such information includes the usage history on each provider and user; enrollment lists of providers and users, and tracking data on who is using the platform, including responses by both providers and users to each other's communications.

The invention provides access points to providers and users through a consolidating icon/agent in the taskbar, system tray, or screen of a desktop or mobile device. A bi-directional communicator allows the use of all forms of communication, including the Internet, e-mail, web casting, blogging, and mobile communications devices such as cell-phones, personal digital assistants, desktop Interactive Video, and other mobile platforms. The access points to providers leverages the internet need for broadcast television.

The icon/agent is a single Icon that lives in the system tray of the Computer or Mobile Device Desktop that leverages the power of the Internet without a dependency upon the World Wide Web or Carrier. Though it is a Single Icon in the system tray of the computer or mobile desktop, it can house as many clients as a user wants to opt into. The content can be completely Interactive 3 layers deep. The icon or icon/agent only represents a portal where the icon itself doesn't have to be present for all attributes of the system to function because the code is installed.

a. (Content to Desktop): Content can interact with the desktop, i.e. someone can tear through the desktop background, walk over to an icon on a user's desktop, grab that icon, throw it towards the screen and cause an effect of the screen cracking from the impact of that icon hitting the screen.

b. (Content to User): The Content can encourage the user to click on or mouse over or interact in general to items within the content to cause real time actions to occur, i.e. the content is someone speaking who is wearing a designer outfit while speaking and the user can click on the contents clothing to make a purchase of that clothing or, the content pulls a mobile phone out of his pocket and asks the user to dial their number into that phone that the content is holding up to the screen so that the user can opt into a mobile campaign.

c. (User to Content): The User can click on Advertising or content to create a reaction by the Content to that click.

The icon/agents look, color or media attributes can be changed dynamically when a client reaches out to their consumer through their specific portal within the Agent. Each portal can be Alerted, Tracked, Targeted and Advertised to independent of the total Agent. The Agent itself is dynamic and can thus change all of its total attributes, or the portals within it can be changed within seconds. Clients reach to its consumers, or a consumer's reach to the Client can happen assertively through the Agent. Any content can be delivered through the Agent, whether it is video (any format), graphics, text, telephony, or even Live Streaming content. Any form of merchandising can occur within the Agent environment from Interactive advertising, to cost per click merchandising. Content can be sent via a calendar and can thus be sent but set not to display until a later time or date. This enables on or Off Line content distribution so that once the content is sent the user does not have to be online when the content is delivered to the user's desktop or mobile top. Each business or agent can upload their own Advertising Header at the top of their page and can execute other programs through agents as well.

2. Consumer Enrollment Function.

The provider Web site includes automated, enrollment software for allowing users to enroll. Users may enroll with an itt Rom™ promotion or on their own initiative, ‘the user registration process may include the following: (1) performance of the instructions contained in the itt Rom™ promotion, e.g. a prize code or login password; (2) input of basic user data such as name, address, zip code etc.; (3) the automated generation of a user id; (4) user selection of preferences for receiving content and marketing communications; (5) generation of one or more user accounts to track user data, transaction and usage history, and responses. The agent can be installed from any computer or mobile device to another computer or mobile device and maintain all attributes and recorded interactions. The content can be delivered via an email link, website, bulletin, interactive In Front Video, thumb drive, CD Rom, DVD, sent to a friend or through a direct link etc. . . .

3. Provider Enrollment Function.

The provider Web site includes enrollment software for allowing providers to enroll. Providers may register their use of an itt Rom™ promotion or campaign. The provider registration process may include the following: (1) inputting of the instructions contained in the itt Rom™ promotion, e.g. a prize code or login password; (2) inputting of provider responses to user registration; (3) analysis of basic user data such as name, address, zip code etc.; C3) analysis of detailed user data such as age. weight, etc.; (4) amalgamation of basic and detailed user data; (5) analysis and responses to user selection of preferences for receiving content and marketing communications: (6) analysis and responses to user data and preferences; (7) generation of one or more provider and campaign accounts to track user data, promotional data, analysis, user responses, sales, etc and can launch from In Front Video (IFV) as well.

4. Targeted Marketing Communications Generator.

Methods and systems for generating and paying for targeted marketing communications are disclosed. The unique ability of the invention to add value for advertisers and providers through access to user and consumer data means that the user of the invention may charge commissions. Methods and systems for creating advertisements and advertising campaigns and generating reports and charging commissions are disclosed.

5. Invention Disclosure and Description of Figures.

The following descriptions are presented to enable any person skilled in the art to make and use the invention, perhaps with some experimentation. For purposes of explanation, specific nomenclature is used to provide a thorough understanding of the present invention. However, specific examples are used only to describe and not to limit the scope of the invention.

Various modifications and adaptations of the invention will be readily apparent to those skilled in the art, and the general principles defined here may be applied in other embodiments and applications without departing from the scope, nature, and spirit of the invention. The present invention is to be accorded the widest scope consistent with the principles and features described here and not limited by the embodiments or examples presented.

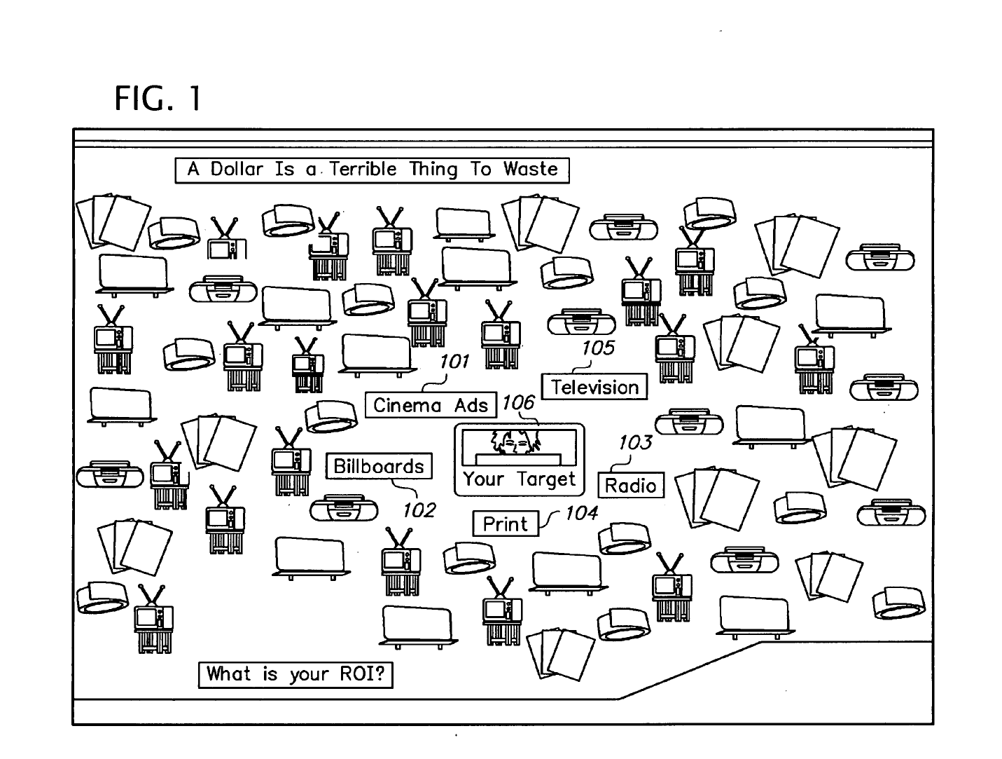

Referring now to the drawings, FIG. 1 is an example of the world of advertising in which advertising dollars are spent, e.g. on cinema ads 101, billboards 102, radio 103, print media 104, and television 105. The aim of all of these communications means is to reach the individual consumer or user target 106.

The conventional advertisements are short-lived and one-way, in that consumers and buyers have no easy means for communicating with the provider of the message other than transacting a purchase. Providers have no ability to tailor ads and send them to targeted groups or individuals intelligently. Neither side has any means to establish a mutually beneficial relationship and build it continuously.

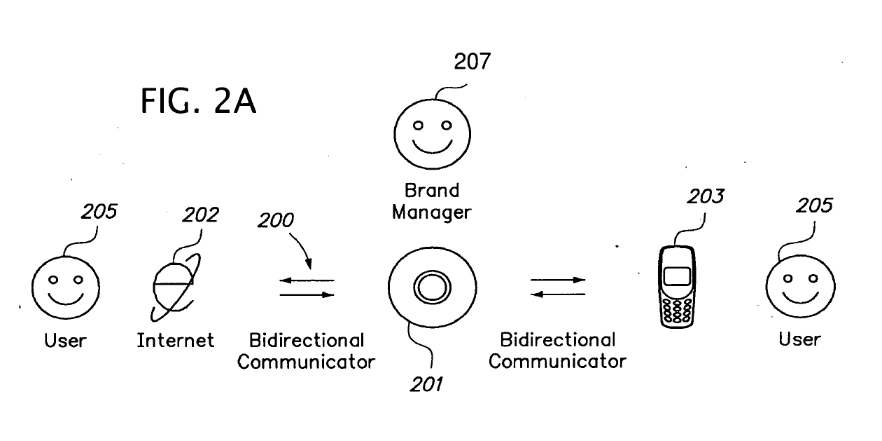

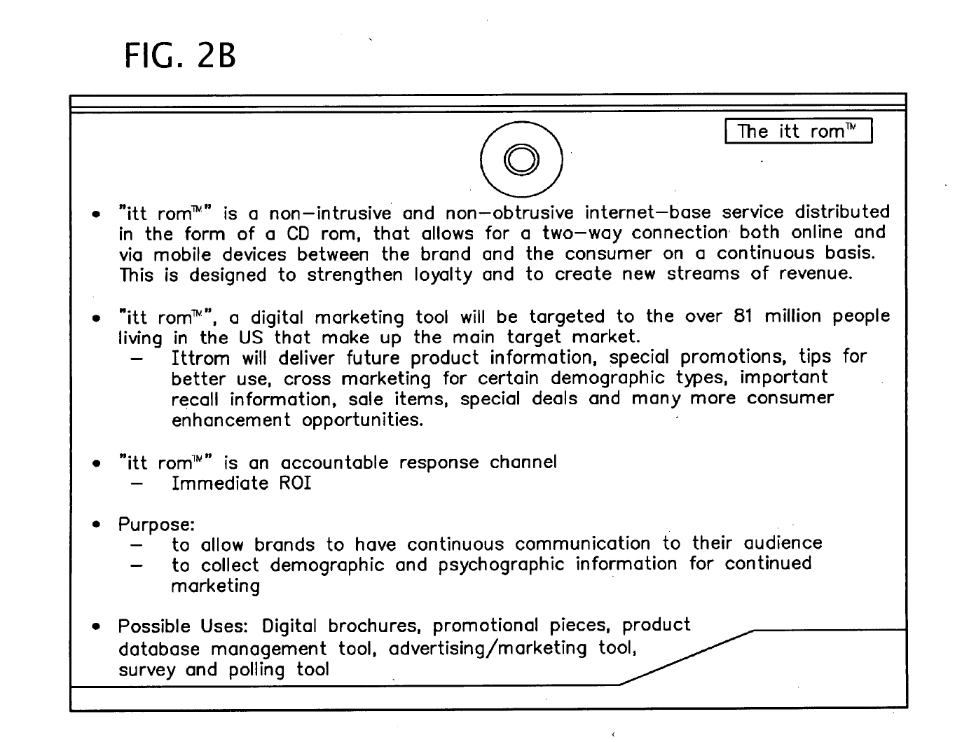

FIG. 2A illustrates the invention's use of a CD 201 as a means for a provider to initiate communication with consumers, users 205, and brand managers 207. Using a CD 201, the itt Rom™ is a device, and method for allowing bi-directional communication 200 between users 205 and providers (brand managers) 207 via the internet 202 and mobile communication devices such as cell phones 203. The CD provides the means for the consumers initiating a relationship with the provider or advertiser. The supporting software applications of the invention enable the provider and user to maintain a long-term, continuous relationship. A Touch is a communication from the provider/advertiser to the user/consumer. The All-In-Touch system allows the user to control the type, frequency, and source of the touches received, while also allowing the provider to tailor content to targeted users. All-In-Touch allows providers to view the decision made by their consumers by product or service and by individual Touches.

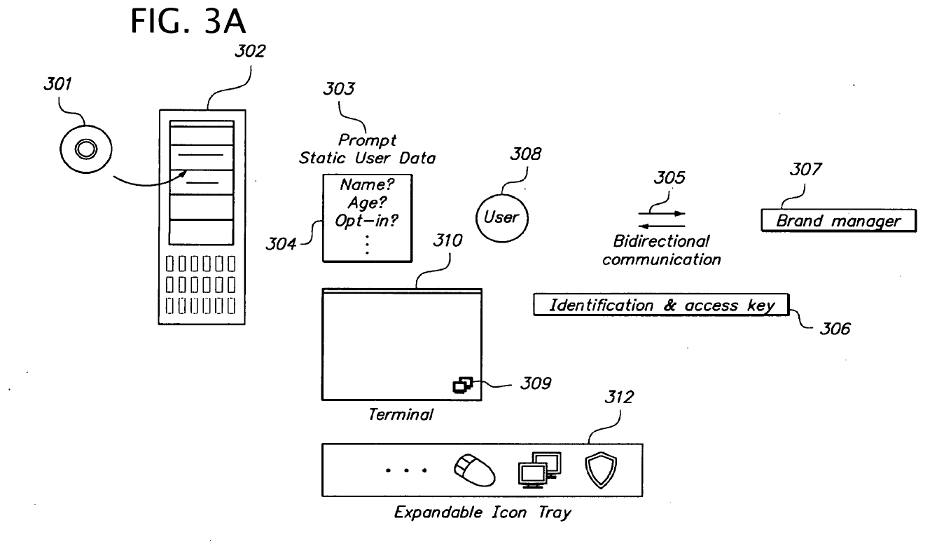

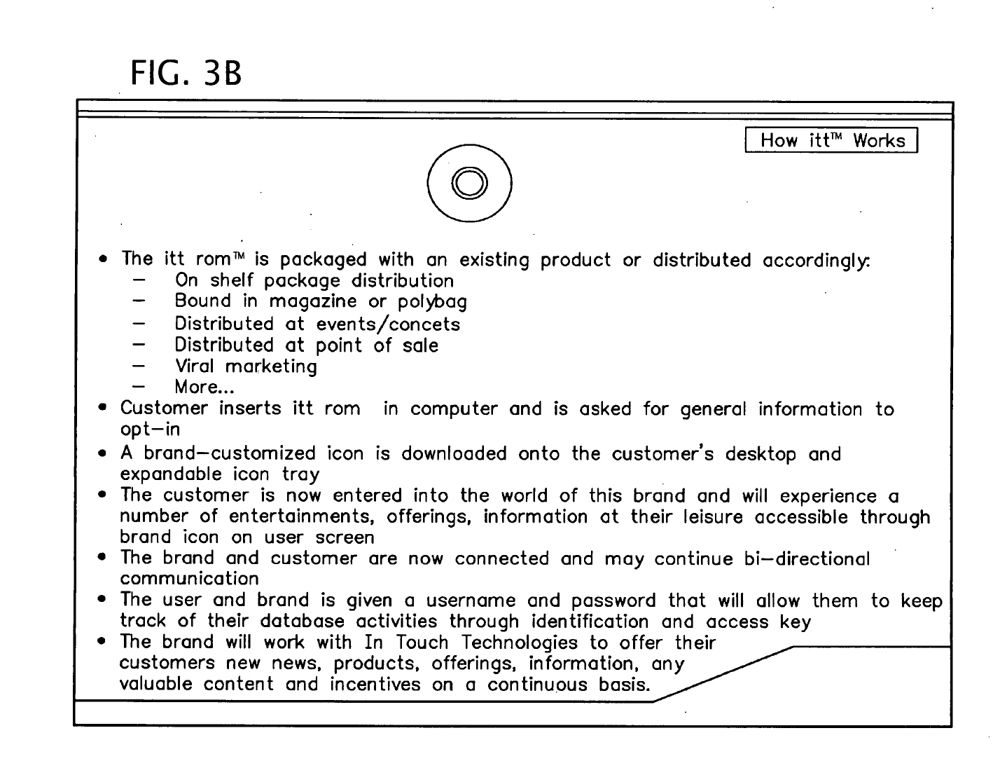

FIG. 2B discusses further how itt-Rom™ works. The itt-Rom™ is non-intrusive in that the user controls the communications from the provider. The itt-Rom™ also provides an accountable response channel because each user is assigned a unique identification-access key 306 (shown in FIG. 3A).

In this example, the CD is distributed with an event, product or service. Once the user has the CD, lie may login into the website or the provider and opt-in and provide user data. The CD is only one of many ways of initiating contact between providers and users, and the concepts describe in the present invention may be applied to other means for the users 205 (shown in FIG. 2A) to initiate the relationship and bi-directional communication 200 with the brand managers 207.

FIG. 3A illustrates how itt Rom™ works. The itt Rom™ technology is packaged with an existing product or distribution means. The CD or other trigger is packaged with an existing product or distribution media, e.g. on shelf packaging, magazines or polybags, event distributions, point of sale distributions, and viral marketing. As a first step, the user 308 inserts the CD itt Rom™ 301-302 and is prompted for basic user information i.e. static user data 304. Once the user opts-in 303, the brand's icon 309 is downloaded onto the customer's desktop terminal or communication device 310. Thereafter the user 308 may access the brand manager 307 through the expandable provider icon tray 312 and use the bidirectional communicator 305.

FIG. 3B presents the advantages of itt Rom™ and the invention. One of the principle purposes of the itt Rom™ is to enable the user to opt-in 303 (shown in FIG. 3A) and provide to providers basic user data 304 at first and later on more detailed information on preferences and habits. The invention consolidates the user's access to all of the providers through a common platform and expandable icon/agent in the system tray or taskbar 312 on the screen of the desktop, communication or mobile device. Multiple brands from all opt-ins find their way into a single point of access via a single dynamic icon/agent 309, 310 and 312.

Once the provider and user have established their initial connection through the bidirectional communicator 305, each is provided with an account, password, and unique access-identification key 306. By using this key, the user may consolidate their user preferences across multiple brands, while the multiple providers may amalgamate the individual input of each user to create a more complete user profile.

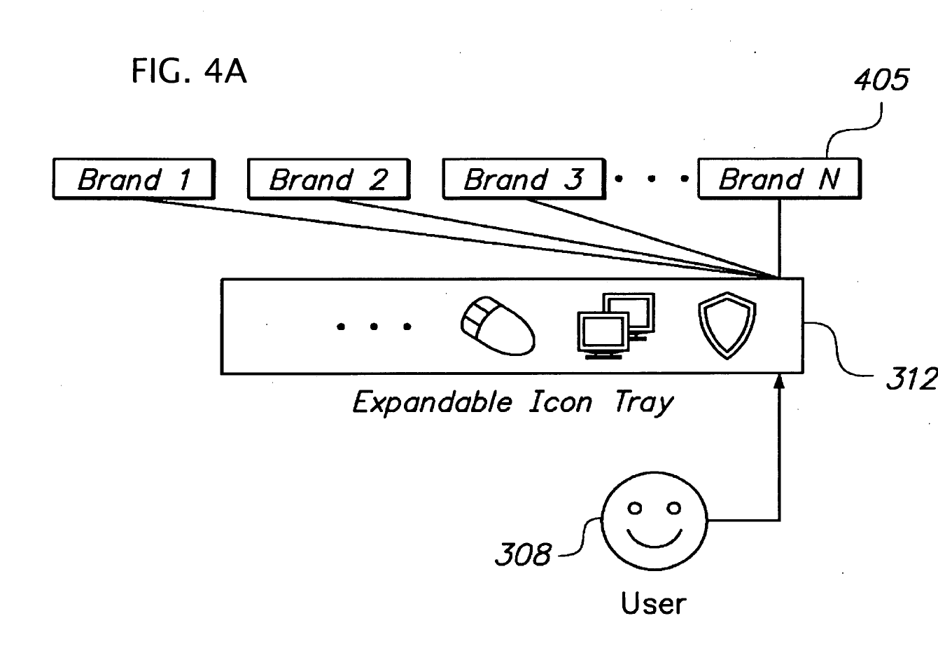

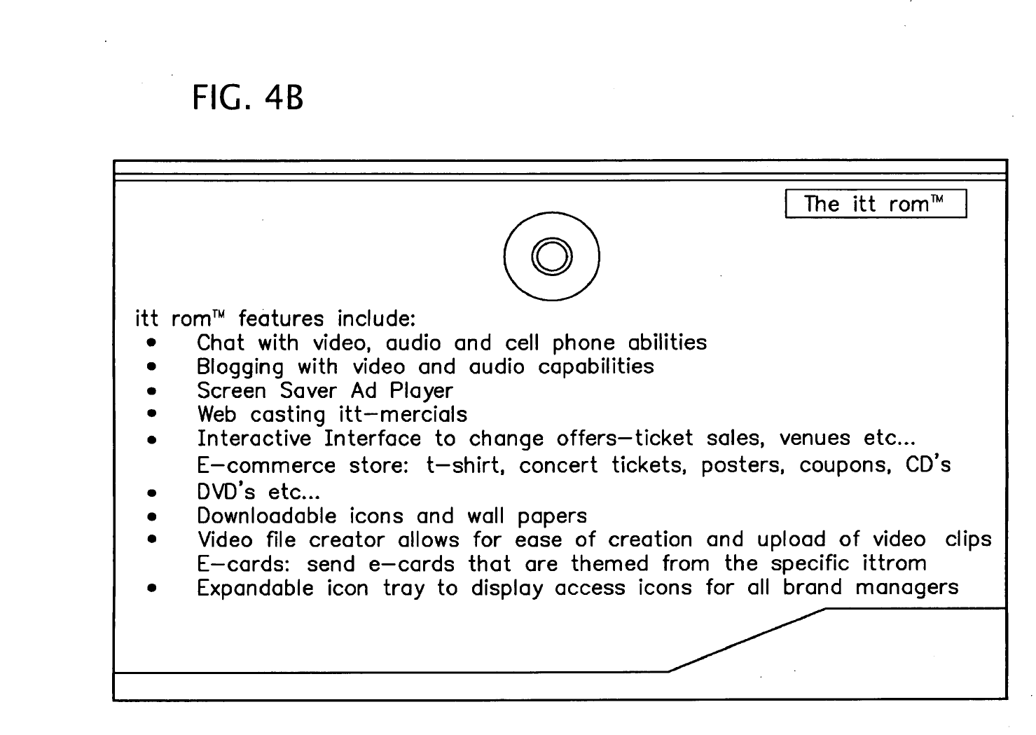

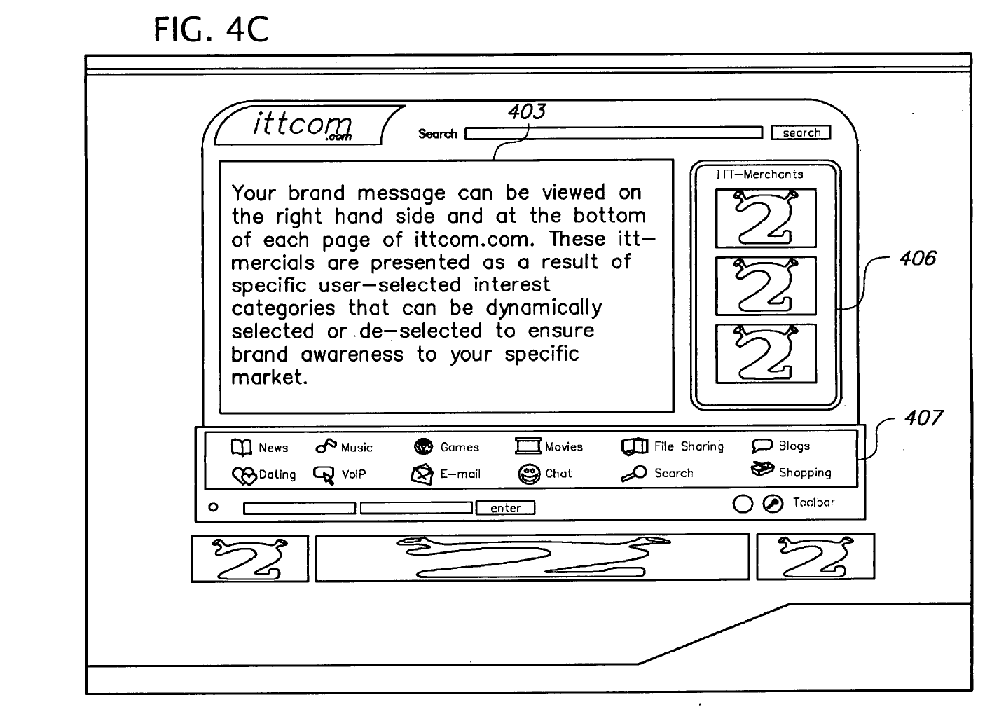

FIGS. 4A and 4B illustrate the advantages to the user and provider of using the invention. FIG. 4C shows a contemplated screen image showing the integration of the itt Rom™. By using the expandable icon/agent 312, the user 308 may access and receive specialized or tailored content from the providers and brand manager 405 (shown in FIG. 4A), receive coupons or special promotions, and access information with limited distribution Brand managers 405 will be able to have direct communication with targeted consumers, opportunities for sending tailored information 403 (shown in FIG. 4C), to self-selected, targeted groups, and measure return on investment or return on advertising based on user metrics and advertising results. While in this example the CD is the enabling device, the invention may utilize other devices to begin, this process.

FIG. 4B illustrates other features of itt Rom™. Chat, video, cell phones, blogging, screen savers, Web casting, interactive sales, e-commerce, e-cards, and other communication forms may be integrated with itt Rom™ 407 (shown in FIG. 4C). For example, coupons may be distributed with on-line ticket sales and contain instructions for accessing the invention through a special web page 403, 406.

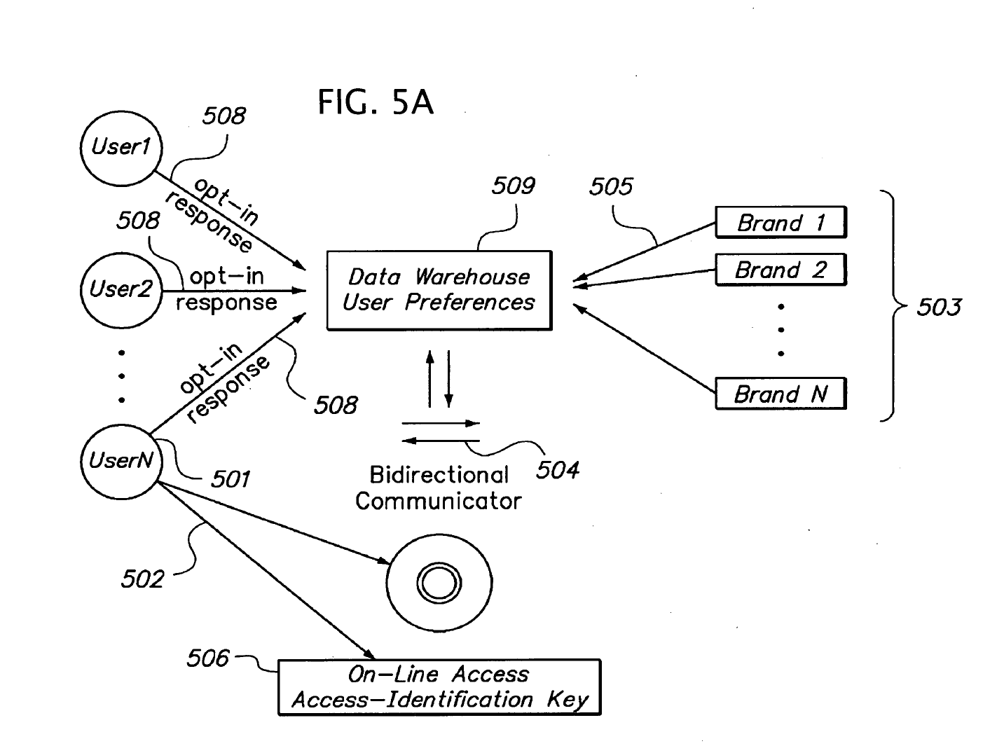

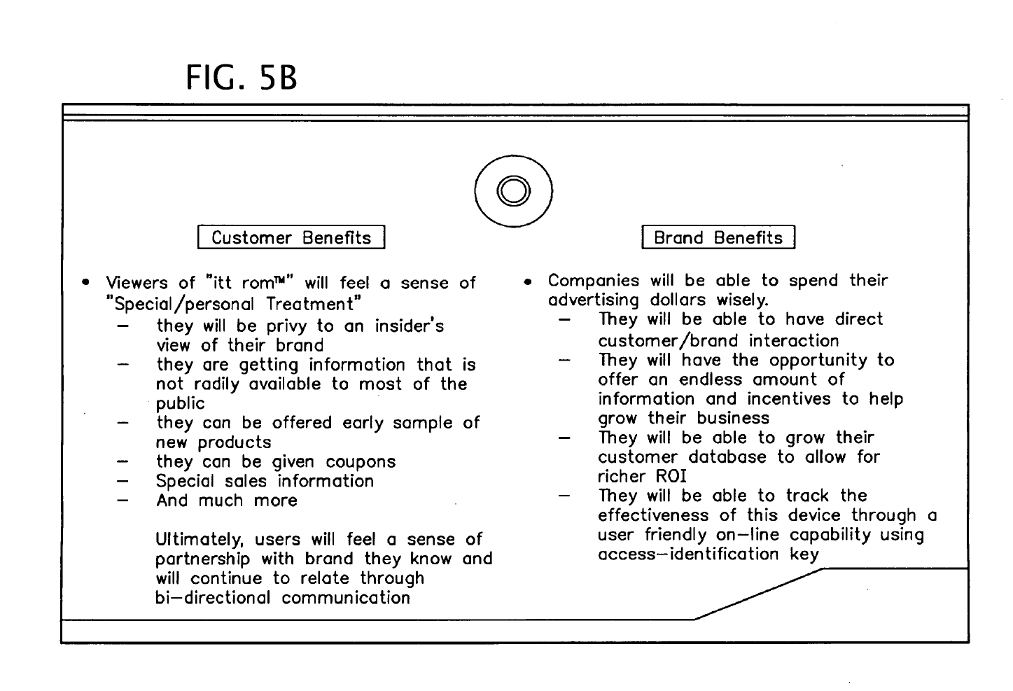

FIG. 5A illustrates how the users 501 receive special benefits from the brand providers 503, after opt-in 508. The users 501 communicate 502 using their On-line Access Identification key 506. Brand managers or providers 503 will be able to spend advertising dollars wisely, based on the users' opt-ins 508 and preferences stored in the data warehouses 509. Each brand manager 503 sends communication 505 to the data warehouse. As can be seen in the illustration, providers may amalgamate user data from one or more opt-ins, user sessions, and user preferences to tailor special content for each user individually, and users may consolidate their preferences and opt-ins options over multiple providers, all through the bidirectional communicator 504 and data warehouses 509.

FIG. 5B compares and discusses the advantages of the invention for customers and brands. The In Touch Application is made available on a CD rom or other device distributed with an existing product or service. Or the In Touch Application is downloaded via the internet. The consumer opts-in and is provided links to specific information, promotions or other provider content. To facilitate communications with the users, a brand-customized agent is placed on the taskbar of the user. To facilitate accessing multiple providers and many alerts, the icon/agents for each provider and alert are stored in a single icon/agent, which expands upon demand or by a click.

The Multi-Level Marketing (MLM) has a variety of rich media notifications that works with any level of Interactive rich media content, user established preferences (Select Date, Time, Kinds of Notification, etc.). The client has backend reporting, tracking, targeting and grouping systems that are easy to use and manage with a client “mini backend” Graphic User Interface (GUI). The MLM has a personalized direct Interactive Introduction without individual interaction where a top presenter make presentations to thousands of prospects one on one, in a very personalized way all at the same time and all without the Web. A personalized automated prospecting system offering increased productivity with decreased work and with less cost of prospecting in terms time, energy and effort. The MLM allows a marketing system where a new member can begin to reach out to his warm and cold markets without the fear of not being able to deliver the message the way it was delivered to him or her. The Top presenter can deliver presentation for everyone in the organization at all times of the day. The presenter addresses each invitee by their first name while referencing the person who sent out the friend's invitation. i.e. “Hello ‘Tom”, my name is Dennis Perry, I know that you don't know me but your good friend ‘James” asked me to come and speak to you about this opportunity, etc.”

The MLM has personalized auto responders that are time activated responses via Email, on desktop and on mobile devices. All or parts of the content from a presentation are downloadable digitally without hard copies or DVDs. The downloadable content can include but not be limited to; corporate materials, handouts and training materials.

An application programming interface (API) has the ability to integrate external Calendars and other attributes into environment. The environment allows one user to can send to a friend viral component. The data that is sent to a friend is full trackable. It has color coded date initiated Auto Responding via Email, Desktop and Mobile, and may include Video Recording in Send to a Friend invite. There is an ability to auto Import of Contacts from major email engines. Yahoo, MS, Gmail etc. Contacts information from a user's .CSV file can be imported or exported. One user can send to a friend, or another user, a letter with an embedded link to allow the recipient to opt into an equal system. There is further direct connecting to senders shopping cart for sign up.

The MLM has a social/lead generation replicated site. The site has “Go Live” that allow members to appear live in a live branded video and audio enabled panel for other member to interact with and record Video Mail to allow members to send recorded video content to fellow members, email addresses and mobile phones. There are chat rooms with video and audio enabled chat rooms which can be set up to be either public or private. The “Go Live” operates over the Web, desktop and mobile devices to allow others to join a user on their profile page in a mini Chat environment. Two or more users can change the room to private as well to allow or block others from the “Go Live” content. The Chat rooms operate in a video and audio enabled Chat environment with a docking feature that allows a user to see whomever they want to see in visible thumbnail boxes. The thumbnail boxes are dynamically adding and a user can accommodate and see as many people live as you want. A user can record a video that will play on their profile page when they have page visitors.

A collaboration tool allow for power Point or similar documents, video files, etc to any number of participants in real time with full white boarding and file sharing, etc. A live player “Any web” placement allows members to place their Live Video Player on any other web environment so that they are able to do live interaction from where ever that player is placed. The system includes an on web to on desktop automated notification integration module. An advertising Injection Engine shows product(s) that are up for sale and provides revenue generation.

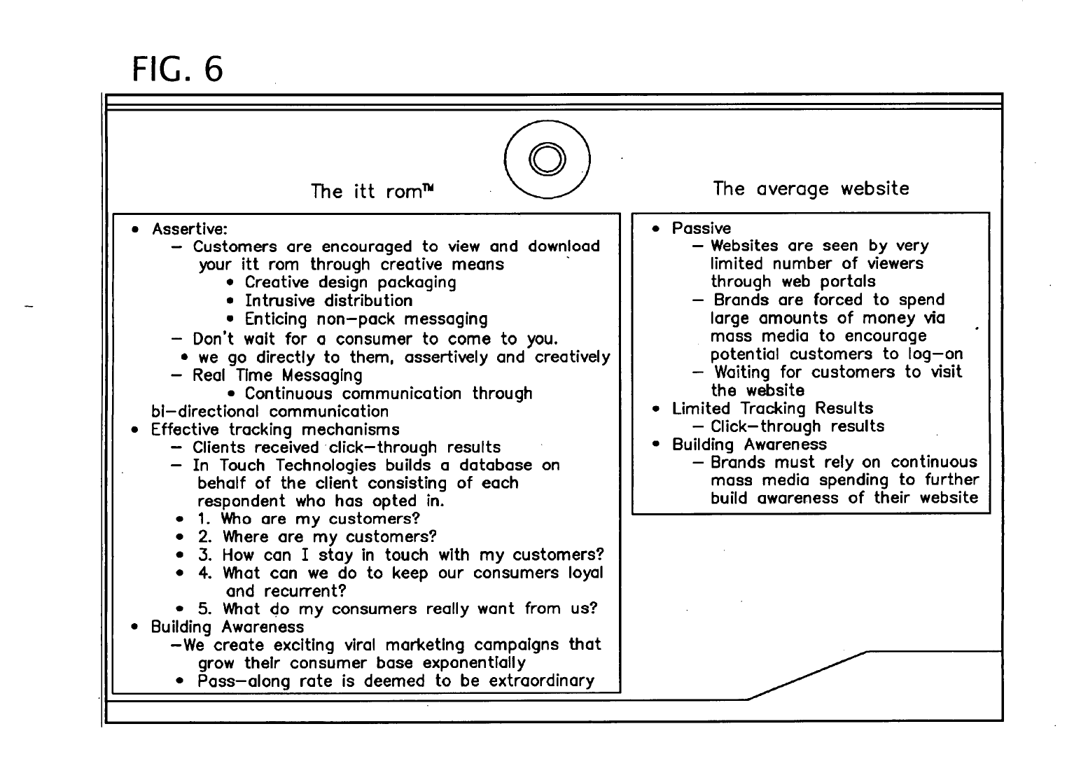

FIG. 6 illustrates the advantages of the itt Rom™, such as building brand awareness through viral marketing over the typical passive website. Itt Rom™ enables user-initiated real-time communication through the bi-directional communicator, whereas the average website waits for consumers to visit. Itt Rom™ provides effective means for tracking consumers through user-initiated opt-ins and user sessions in which users provide user data, whereas the typical website's tracking is limited to analyzing the results of anonymous click-throughs.

Whereas the average website still depends on mass media ad campaigns to generate interest and build brand awareness, itt Rom™ encourages viral marketing campaigns that grow organically. In this illustration of the invention, while the CD may he tied into other items and activity, e.g. chat, cell phones, blogs, screen savers, web casting, interactive sales, and specific products such as t-shirts, concert tickets, and e-cards. Other devices may serve as the initial point of contact between the providers and the users.

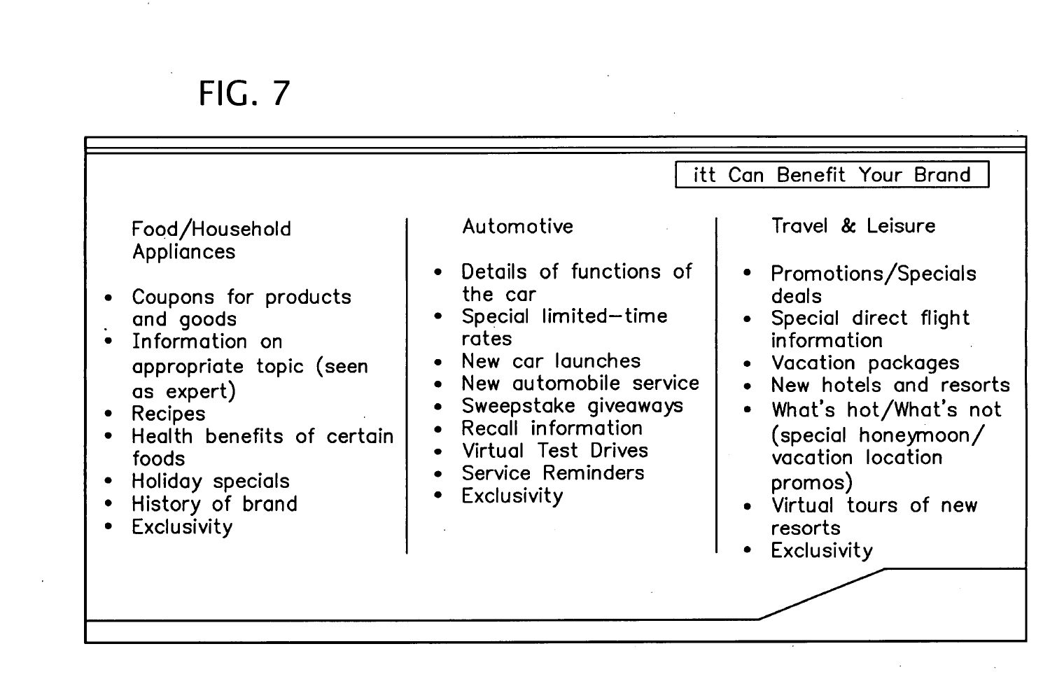

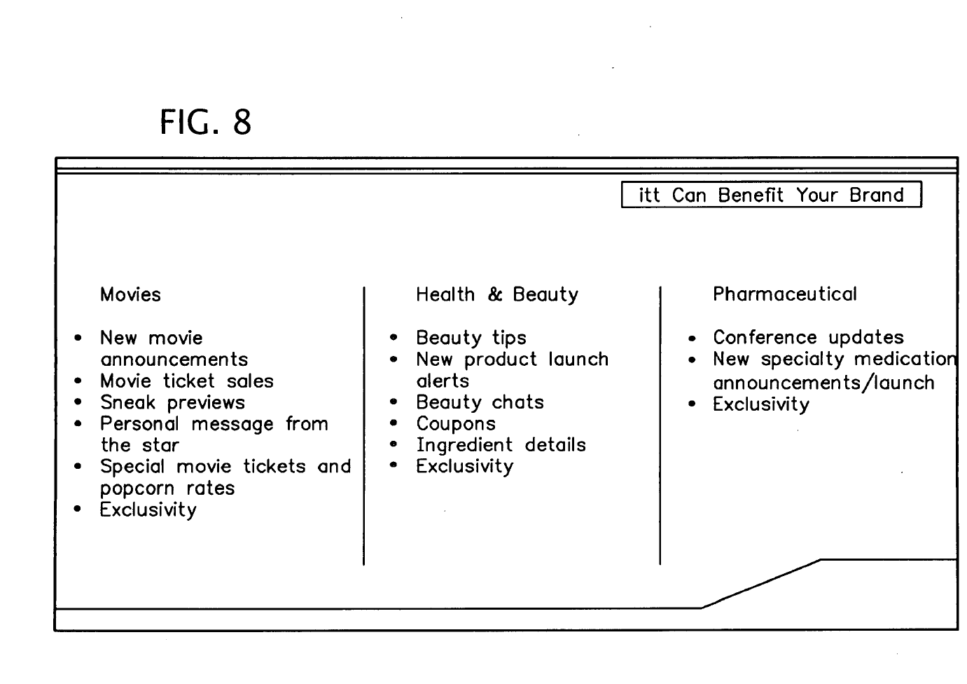

FIGS. 7 and 8 illustrate how the invention can build brand value through targeted marketing communications and demonstrates the uses of itt technology. Providers, brand managers, and advertisers need to communicate with users/consumers frequently, e.g. announcing a new product, selling an existing product, offering a special promotion, opening an exciting sweepstakes, making coupons and discounts available, informing about product recalls, announcing special events, etc. Agents deliver the messages. Agents appear as icons on the screens of users. Agents are ignited from the desktop, after which users are prompted to click on the agent/icon. Messages appear in various forms.

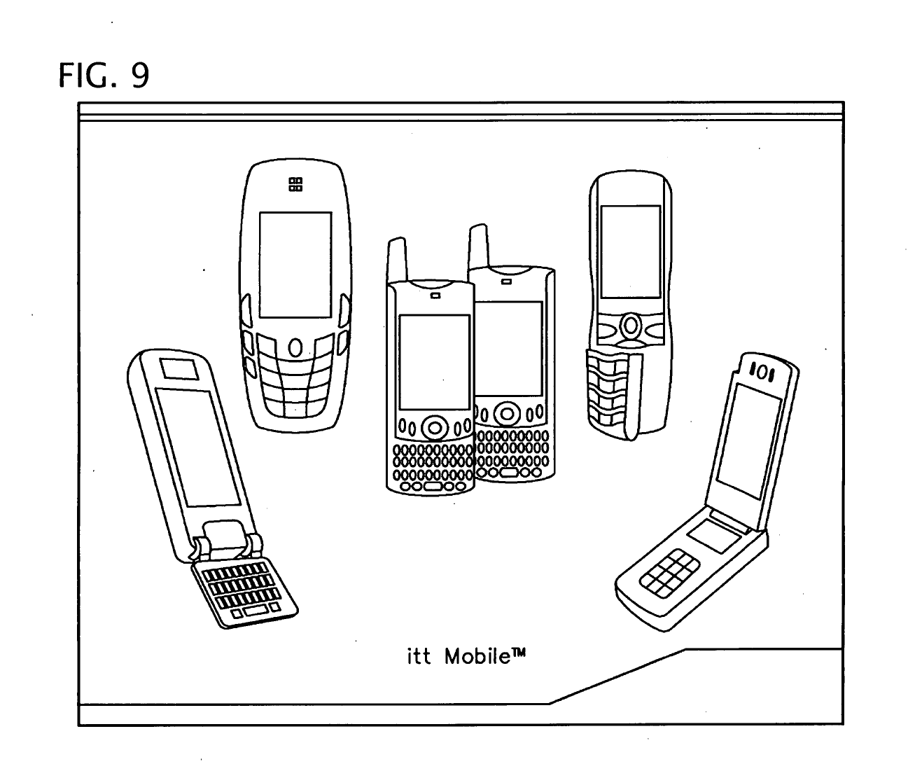

FIG. 9 illustrates itt Mobile™ and the invention's use of mobile communications technology, including promotional coupons, streaming video commerce, mobile location marketing, chatting, blogging, mp3 downloads, polling and voting, ringers, graphics, messaging, sweepstakes, games, and other applications. Each of these uses can be tied to the provider and/or advertiser.

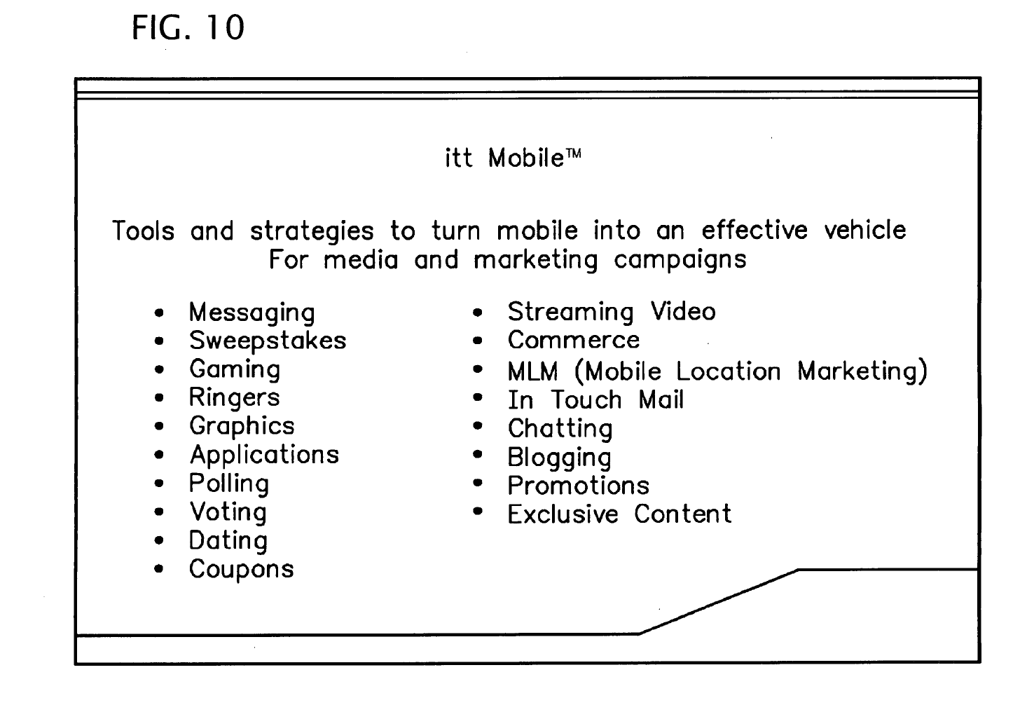

FIG. 10 illustrates itt Mobile™ and how the world of mobile communication devices, including the cell phone, may be adapted to the invention through itt Mobile™. While the user may communicate through a personal computer or any communication device, the mobile phone takes best advantage of the invention's ability to respond to user input.

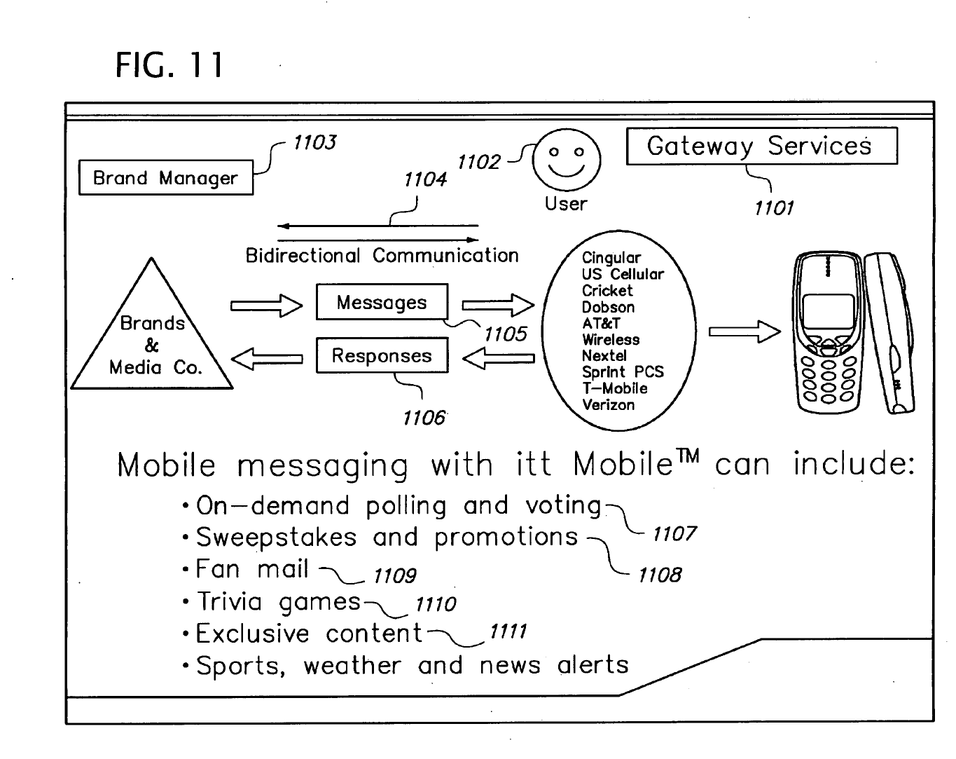

FIG. 11 illustrates how Gateway Services™ 1101 and communications between providers and brand managers 1103 and consumers and users 1102 may occur through mobile communication devices such as a cell phone that are integrated into the bi-directional communicator 1104. Through the bi-directional communicator and intelligent software for analysis, providers may keep marketing and advertising campaigns up-to-date with the most current communications technology with messages 1105 and responses 1106. In addition, consumers may opt-in and provide user data in real-time. In one implementation of mobile messaging with itt Mobile™ through Gateway Services, various providers such as pollsters and voting machines 1107. sweepstakes and promotions 1108, fan mail 1109, games 1110, news, sports, and weather channels, as well as exclusive 1111 content disseminators make content available to consumers while also enabling the consumer to react to the tailored content received through responses 1106.

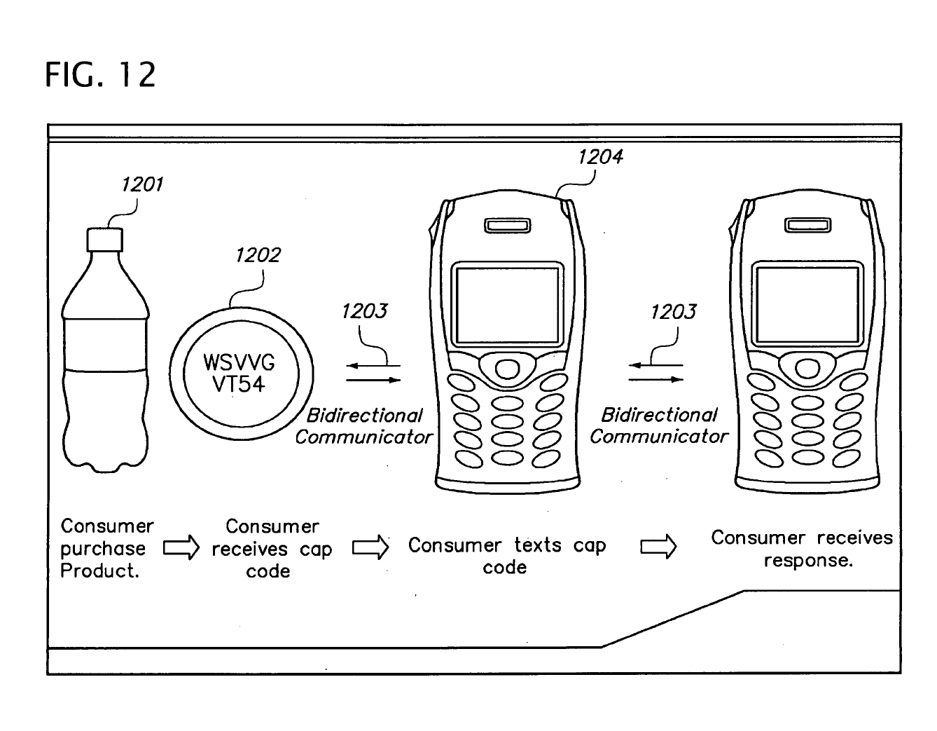

FIG. 12 illustrates how a provider message can be used by a user to communicate with die provider and receive a response through one aspect of the invention, i.e. the bi-directional communicator. In one implementation, the consumer purchases a product 1201 that contains a code 1202, e.g. a soft drink with a cap code. The consumer then uses the bi-directional communicator 1203, e.g. through a cell-phone 1204, to enter the code 1202, thus initiating a user session to opt-in or provide user data.

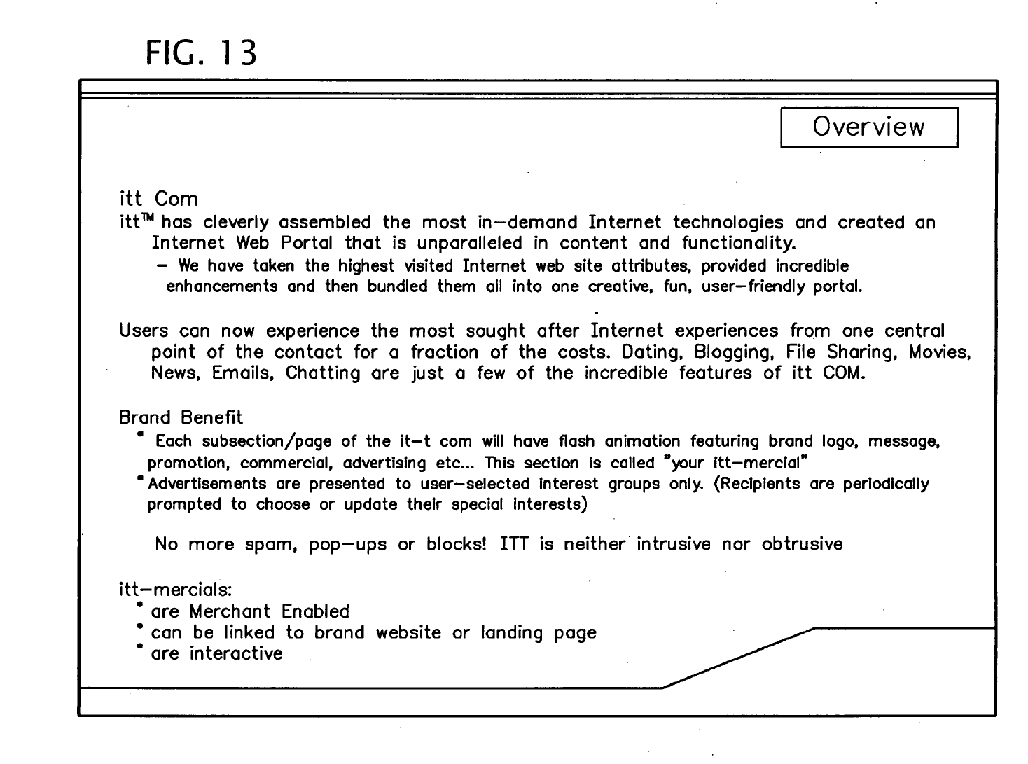

FIG. 13 shows itt Com™ benefiting brands, including bundling Internet communication technologies into a single service: the user may access dating, blogging, file sharing, news feeds, e-mail, and chat through a single interface of fit COM. The provider creates an itt-mercial targeted to users who have previously opted-in or indicated a preference or consent to receiving targeted marketing communications. Periodically users are prompted to renew their opt-in or modify their preferences, itt-Mercials™ allow the user and provider to communicate interactively. Since the generation and receipt of itt-mercials depends on user initiated contacts, there is no more spam, pop-up ads or blocks.

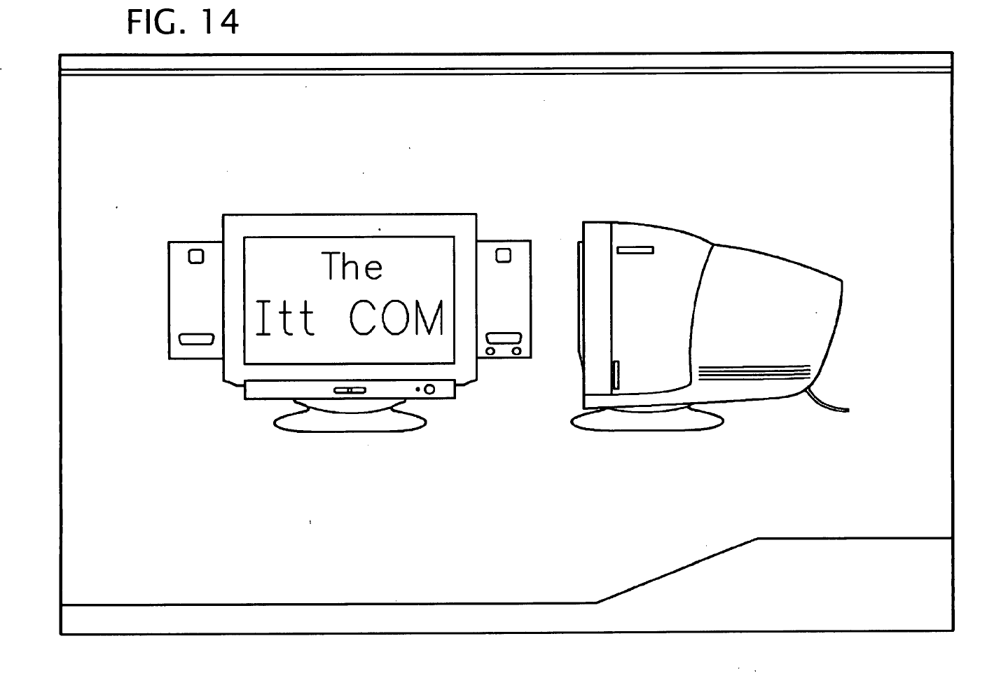

FIG. 14 illustrates some of the information available to providers through itt Com™. The user selects preferred brands or products; the provider analyzes the user preferences and then creates tailored content to send to targeted users. The provider is able to response to user input in substantially real-time, while the user is able to change his preferences at any time.

The communications platform enables intelligent bi-directional communicator between a plurality of providers of information and a plurality of users of information utilizing an interactive windowless video wherein the interactive windowless video includes an interactive advertising where at least one item in the interactive advertising is selectable for purchasing. The windless video further has the ability to interact with the users desktop including moving or altering items on the user's display. The desktop is either a desktop computer or a mobile communications device such as a phone or PDA. User preferences are specified by the users through a user specifying process specifying type, frequency, and source by provider of provider communications desired to be received by the users, and provider preferences specified by providers through provider specifying process specifying the user profile of target group of users desired by provider.

A user cart can have a cart that including a list of users meeting the provider preferences for users and containing provider data from provider data warehouse, and means for sending the user cart to a targeted group of users. The platform provides the generating and sending targeted marketing communications, wherein the targeted marketing communications contain information based on the user preferences and user data warehouse and provider data warehouse, the targeted marketing communications being sent to a target group of users through the bi-directional communicator. The targeted marketing communications is based on the user responses to create modified marketing communication, the modified marketing communication being sent to a target group of users. The system offers referrals with a payout system so that members are able to receive a percentage of the ad dollars generated by site traffic from themselves and their referrals. Referral Tracking and Payout go up to 7 levels deep and members can also Real Time track their signups and money generated.

A desktop agent that sends and receives real time broadcasting from a video instant messaging (VIM) system within a non visible player window where a user Installs a desk top agent, adds buddies to the desk top agent buddy list receives the video instant message notification that at least one the buddy is online and or trying to communicate with the user and the communications activates the user's webcam. The user performs steps to key background where the user selects to send video of themselves to the buddy or buddies, and the user creates the video instant message that allows other buddies and or people to join the video instant message on the buddies or peoples desktop. The desktop is a laptop computer, cellular phone or PDA.

The Desktop Broadcast Network is a media broadcasting network that provides incredible, fully interactive, rich media content for Entertainment that seamlessly traverses the Web, the Desktop and the Mobile top with creative content. The primary core of the innovation of this Application is our Desktop Interactive Windowless Video (DIwV). The technology allows for Interactive and Responsive rich media content that is presented in a non apparent window environment on the Desktop of a computer. This content can display and be Interactive and Reactionary while the user still has the ability to surf the web, work on excel spreadsheet, or do any of their normal computing activities.

The DIwV was made to be non-obtrusive and non-intrusive thus it functions in a Windowless environment is completely Interactive and operates with up to five levels of deep. These five levels of depth include where; a. Content can Interact with Desktop, b. Content can interact with User, c. User can interact with Content, d. Content can Interact with Web and e. Content can interact with Mobile devices such as cell phones and PDA's and television screens using a non visible player. The television top leverages the client and IPTV without broadcast television.

The DIwV is completely reactionary to allow a user to interact with items in the broadcast that then creates a specific reaction by the content. The content can elicit an action to the User who can then react to that request for action by the Content which can then trigger a new reaction within the broadcast. The responses from the user are completely Track able for analysis. The content is available through any number of Channels (Comedy, Business, Drama, Horror, etc.)

Developers programming interface (API) to allow creative producers to create and publish their own content that will be available in the Network for advertising that is provided in real time advertising in several ways including but not limited to interactive couponing, real time polling and surveying, elevator advertising, banners and fly ins. The API is supports any type of Media content formats.

The desktop agent allows a user to add, delete, block and allow buddies from the buddy list. The desktop agent further provides for creation of an in front video that allows the desktop agent according to claim 8 that further includes creation of an in front video using a video instant message engine where a user records and keys a video from a webcam at a physical location without a green or blue screen background. Passing the video to an application programming interface (API) that allows the user to create, upload, and position the user's in an in front video (IFV) on a page, and when the in front video is created and uploaded the application programming interface creates a string of code dynamically that is copied and pasted onto a website created by the user and the in front video will play on the user's website within a nonvisible player environment whereby the physical location is not visible on the user's website. The in front video can interact with items on the user's website and with items on a viewer desktop. With IFV a user can create any level of Interactive Rich Media content to be displayed as an In Front Video on both Web, mobile device and on a Hotspot. IFV's can be video or interactive graphics.

Members can create IFV that can be uploaded directly to their Profile Page. Members can copy IFV code and place on any other web page and have it function. The members can further set specific page play parameters for an IFV. An advertiser can set how often they want viewers to be able to see IFV when their site is visited such as just time the site is viewed, every time the site is viewed or at particular user actions or time intervals. Members can schedule IFVs to change on specific days or times automatically. A user or the advertiser/promoter can establish where an IFV is on their web page. The location of the IFV can be top right, top left, bottom right, bottom left, top center, bottom center or absolute center. Members can determine the size that they want the IFV to play in. Members can create as many IFVs as they would like and determine the order and frequency that each IFV will be shown. IFVs can be either uploaded or pointed to on a server for streaming. Members can view reporting on IFV activity including but not limited to the number of views and the number of Clicks from IFV. The count will list IP Address that view came from IFV.

The creation of an in front video comprising uses a video instant message engine where a user records and keys a video from a webcam at a physical location without a green or blue screen background. The video is passed to an application programming interface (API) that allows the user to create, upload, and position the user's in an in front video (IFV) on a page, and when the in front video is created and uploaded the application programming interface creates a string of code dynamically that is copied and pasted onto a website created by the user and the in front video will play on the user's website within a nonvisible player environment whereby the physical location is not visible on the user's website.

The desktop is laptop computer cellular phone or PDA. The in front video can remain stationary on the website or page regardless of scrolling or zooming. The application programming interface visually deletes the physical location whereby the user interacts on the user's website without the physical location as a background. The image of the front video can interact with items on the user's website and with items on a viewer's desktop and allows the video to move and or alter icons or items on a viewer desktop.

Camitt is a Social networking system that provides Global Interactivity. Camitt breaks the trend of closed socialization as is presented by the more traditional social sites such as, MySpace, Facebook, Friendster, and Beebo, etc. The Global social environment has attributes that allow users from any and all social sites the ability to communicate across social networks while never leaving their own primary site and to do so with a plethora of tools including but not limited to uploading photos (such as BMP or JPEG), videos (such as Avi, Mov, Wmv, Flv, Mpg, MPe, 3g2, 3gp, Mpeg, and audio files (such as Mp3, Wav). A user has a Juke box where they can add/remove uploaded songs from the site and create their own play list and close Camitt all together while maintaining their ability to enjoy their add songs. Within Camitt a user can add friends, create a play list of favorites by tagging preferred songs or other similar methods. Camitt members have a Go Live player can initiate communication with Camitt member from their other social site through the Go Live player. Camitt provides criteria searching by any collected information, Gender, age, miles from your home, etc. A cam show provides live Interactive shows that allow for Host, Guests and Participants in a live environment.

Within Camitt a user can create a Vlog which is a Video Blog with a custom video recorder where they can add additional text to accompany the view. A user can create Groups with no limitation to just Friends and everyone else. Groups are created like Mom, Girlfriend, Homies, etc. with upload content that only members of that Group can see. This information is importable from Myspace without a need to rebuild all of your backgrounds and photos, etc. Importing a user's your MySpace brings over MySpace content and places the content correctly into Camitt automatically. Members can insert Really Simple Syndication (RSS) code to their page.

Within the Camitt environment a member can take photos from their Mobile device and send directly to their Camitt page from that Mobile device. Members can shoot videos from their Mobile device and send directly to their Camitt page from that Mobile device. Members can send and receive Short Code messages (SMS) from Camitt to any Mobile Device. Members can send video and text messages to a friend's bulletin board(s).

With the advancements made to cable, satellite and phone-line television transmission, each of these providers can provide unique content and signal to each household and to each television, computer and communications device. With the leverage of the Live Loop system features and functions disclosed in this application extend to the television in a household. The Live Loop system allows users of DTV, Dish Network, Cox Cable and other providers to install and use the Live Loop features and functions to their customer's box and allow users to send notifications to a friend's television. If the sender is using a laptop they can send Go Live, text, video, a Be Right Back message, an image, music or any other content that they would be able to send from a computer that is disclosed in this application. If they are using a mobile phone or PDA they would be able to send Go Live, text, video, an image, music or any other content that they would be able to send from a computer that is disclosed in this application. These actions would allow a first user to appear on the television of another user.

Depending upon the type of remote or communications interface associated with the television users can interact with bilateral text from their stationary or mobile devices to the TV screen where one or multiple friends can join in the texting or communications as a blog like environment but on the actual TV screen where the signal is being provided by the cable, satellite and phone-line and Internet television transmission. Each of these providers can include sellable items that are attached to the communication and or links for additional information. With communications using the television users will have the ability to create Group Communities with whom they can text blog with. It will provide instant communications between two separate friends that can watch and communicate about the same television program as they watch from separate locations.

Advertisers will have the ability to add advertising from a central point that will go with User Interactivity such as but not limited to video, text, graphics and audio. Instead of a department store showing a bulk of products, a user can select the outfit they see and continue to select a color, size, matching accessories and have the product ordered and shipped to them. Commercials can be targeted by any number of criteria during an opt-in process. The target can be based on nearly any category including but not limited to zip code, gender, age, skin type or buying habits.

Thus, specific embodiments of a Communications Platform For Enabling Bi-Directional Communication Between Providers Consumers and advertisers using a Computer Network and/or Mobile Devices using desktop interactive windowless video has been disclosed. It should be apparent, however, to those skilled in the art that many more modifications besides those described are possible without departing from the inventive concepts herein. The inventive subject matter, therefore, is not to be restricted except in the spirit of the appended claims.

1. A platform for enabling an intelligent bi-directional communicator between a plurality of providers of information and a plurality of users of information comprising:
utilizing an interactive windowless video wherein said interactive windowless video includes a interactive advertising where at least one item in said interactive advertising is selectable for purchasing;
said windowless video further has the ability to interact with the users desktop and or television including moving or altering items on the user's display.

2. The platform according to claim 1 wherein said windowless video operates on a computer or television.

3. The platform according to claim 1 wherein said windowless video operates on a mobile communications device such as a phone or PDA.

4. The platform according to claim 1 that further includes including user preferences specified by the users through a user specifying process specifying type, frequency, and source by provider of provider communications desired to be received by the users, and provider preferences specified by providers through provider specifying process specifying the user profile of target group of users desired by provider.

5. The platform according to claim 4 that further includes a user cart, said user cart including a list of users meeting the provider preferences for users and containing provider data from provider data warehouse, and means for sending the user cart to a targeted group of users.

6. The platform according to claim 5 that further includes generating and sending targeted marketing communications, wherein said targeted marketing communications contain information based on said user preferences and user data warehouse and provider data warehouse, said targeted marketing communications being sent to a target group of users through said bi-directional communicator.

7. The platform according to claim 6 wherein said targeted marketing communications based on said user responses to create modified marketing communication, said modified marketing communication being sent to a target group of users.

8. A desktop agent that sends and receives real time broadcasting comprising:
a video instant messaging (VIM) system within a non visible player window where a user;
installed a desk top agent;
adds buddies to said desk top agent buddy list;
receives said video instant message notification that at least one said buddy is online and or trying to communicate with said user;
said communications activates said user's webcam;
said user performs steps to key background;
said user selects to send video of themselves to said buddy or buddies, and said user creates said video instant message that allows other buddies and or people to join the video instant message on said buddies or peoples desktop.

9. The desktop agent according to claim 8 wherein said desktop is a desktop or laptop computer or television.

10. The desktop agent according to claim 8 wherein said desktop is a cellular phone or PDA.

11. The desktop agent according to claim 8 wherein said desktop agent allows a user to add, delete, block and allow buddies from said buddy list.

12. The desktop agent according to claim 8 that further provides for creation of an in front video that allows the desktop agent according to claim 8 that further includes creation of an in front video using a video instant message engine where a user records and keys a video from a webcam at a physical location without a green or blue screen background;
passing said video to an application programming interface (API) that allows said user to create, upload, and position said user's in an in front video (IFV) on a page, and
when said in front video is created and uploaded said application programming interface creates a string of code dynamically that is copied and pasted onto a website created by said user and the in front video will play on said user's website within a nonvisible player environment whereby said physical location is not visible on said user's website.

13. The desktop agent according to claim 12 wherein said in front video can interact with items on said user's website and with items on a viewers desktop.

14. An in front video comprising:
using a video instant message engine where a user records and keys a video from a webcam at a physical location without a green or blue screen background;
passing said video to an application programming interface (API) that allows said user to create, upload, and position said user's in an in front video (IFV) on a page, and
when said in front video is created and uploaded said application programming interface creates a string of code dynamically that is copied and pasted onto a website created by said user and the in front video will play on said user's website within a nonvisible player environment whereby said physical location is not visible on said user's website.

15. The in front video according to claim 14 wherein said user's website or page plays on a desktop or laptop computer or television.

16. The in front video according to claim 14 wherein said user's website or page plays on a cellular phone or PDA.

17. The in front video according to claim 14 wherein said in front video remains stationary on said website or page regardless of scrolling or zooming.

18. The in front video according to claim 14 wherein said application programming interface visually deletes said physical location whereby said user interacts on said user's website without said physical location as a background.

19. The in front video according to claim 14 wherein said front video can interact with items on said user's website and with items on a viewers desktop.

20. The in front video according to claim 19 wherein said interaction allows said video to move and or alter icons or items on a viewer desktop.
